(19) United States
(12) Patent Application Publication
(10) Pub. No.: US 2015/0195546 A1
(43) Pub. Date: Jul. 9, 2015

(54) VIDEO OPERATING AND PROCESSING APPARATUS

(71) Applicant: MediaTek Inc, Hsin-Chu (TW)

(72) Inventor: Kun-Bin LEE, Taipei City (TW)

(21) Appl. No.: 14/662,566

(22) Filed: Mar. 19, 2015

Related U.S. Application Data
(63) Continuation of application No. 11/828,365, filed on Jul. 26, 2007.
(60) Provisional application No. 60/820,609, filed on Jul. 28, 2006.

(51) Int. Cl. H04N 19/196; H04N 19/159; H04N 19/156; H04N 19/423; H04N 19/176; H04N 19/105

(52) U.S. Cl. CPC H04N 19/196; H04N 19/176; H04N 19/105; H04N 19/156; H04N 19/423; H04N 19/159

(57) ABSTRACT

A video operating and processing apparatus includes a memory circuit, a data arrangement unit and a processor. The memory circuit is used for buffering sets of macroblock parameters for operating and processing the video stream, each set of macroblock parameter corresponding to a set of the macroblocks. The data arrangement unit stores the sets of macroblock parameters in the memory circuit, the storing addresses of the memory circuit are determined by a characteristic of the macroblock parameters. The processor is designed for processing the macroblocks according to the sets of macroblock parameters. On processing the macroblocks, the processor needs to reference to sets of macroblock parameters. The data arrangement unit stores the macroblock parameters in the memory circuit with addresses determined by reference to a characteristic of the macroblock parameters, instead of directly storing the macroblock parameters into continuous bits in the memory circuit.

The present application is a Continuation application of U.S. patent application Ser. No. 11/828,365 filed on Jul. 26, 2007, which claims the benefit of U.S. Provisional Application No. 60/820,609, filed on Jul. 28, 2006, which is all incorporated by reference herein.

### BACKGROUND OF THE INVENTION

1. Field of the Invention

The invention relates to a video operating and processing apparatus and particularly relates to a video operating and processing apparatus that handles a video stream based on macroblocks.

2. Description of the Related Art

Video processing, including decoding and encoding, keeps developing rapidly.

Such development brings higher compression ratio so as video can be stored and broadcasted more and more efficiently. Most current video coding methods or standards, e.g. H.264, MPEG2, AVC, etc., are encoded and decoded based on macroblocks. That is, a frame is divided into a plurality of macroblocks. Spatial and temporal relationships among macroblocks are analyzed and utilized during coding for increasing higher compression ratio. Sometimes, several macroblocks are grouped as a basic unit for operation, called macroblock unit here, in some coding tools. A macroblock unit may contain one or more than one macroblocks to be operated.

Please refer to FIG. 1. FIG. 1 is a diagram illustrating a portion of a video frame 100 comprising a plurality of macroblocks, taking H.264 as an example. In FIG. 1 the macroblock units are 16×16 pixels for non-MBAFF (macroblock-based adaptive frame/field) coding and are 16×32 pixels for MBAFF coding, but these are merely examples. If macroblock unit MBU5 is a current macroblock unit to be encoded or decoded, then information from MBU0, MBU1, MBU2, and MBU4 may be used. If macroblock unit MBU6 is the current macroblock unit to be encoded or decoded, then information from MBU1, MBU2, MBU3, and MBU5 may be used. In other words, a current macroblock unit may require information from a top left macroblock unit, a top macroblock unit, a top right macroblock unit, and an adjacent macroblock unit.

Encoding and decoding based on macroblocks are more and more complicated. Every factor during implementation, therefore, needs to be well considered so as to construct a practical product to be conveniently used and accepted by end users.

### BRIEF SUMMARY OF THE INVENTION

A preferred embodiment according to the invention is a video operating and processing apparatus for operating and processing a video stream. In encoding, the video stream may refer to a series of image frames to be encoded into a bit stream. In decoding, the video stream may refer to a bit stream to be decoded into a series of reconstructed image frames. The video stream includes information of a series of frames and each frame includes a plurality of macroblocks. The apparatus includes a memory circuit, a data arrangement unit and a processor. The memory circuit is used for buffering sets of macroblock parameters for operating and processing the video stream, each set of macroblock parameter corresponding to a set of the macroblocks. The data arrangement unit is used for storing the sets of macroblock parameters in the memory circuit, the storing addresses of the memory circuit are determined by a characteristic of the macroblock parameters. The processor is used for operating and processing the macroblocks according to the sets of macroblock parameters. Each set of macroblock parameters corresponds to a set of macroblocks, i.e. one or more than one macroblocks. The term of “set of macroblocks” refer to a storing unit and may not be identical to the term “macroblock unit” as mentioned above. For example, two vertically or horizontally adjacent macroblocks are grouped together as a set of macroblocks. Of course, the set of macroblocks here may refer to a single macroblock, too.

A preferred embodiment according to the invention is a video operating and processing method for operating and processing a video stream, the method comprising: storing sets of macroblock parameters in a memory circuit, each set of macroblock parameter corresponding to a set of the macroblocks, and the storing addresses of the memory circuit are determined by a characteristic of the macroblock parameters; and processing the macroblocks according to the sets of macroblock parameters.

The processor and the data arrangement unit mentioned here may refer to corresponding instructions running on a controller or a microprocessor, or refer to hardware logic circuits, digital signal processor (DSP) and/or any of their combination. The processor and the data arrangement unit may also refer to a portion of an integrated chip or refer to various categories of circuit combination in an end product like a H.264 player. Besides, related circuit logic can be implemented in the form of programs and can also be implemented in the form of ASIC.

With the invention, access to macroblock parameters is more efficient. That is one critical factor to implement a practical application for a complicated macroblock based coding scheme like H.264.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates relationship among macroblocks;

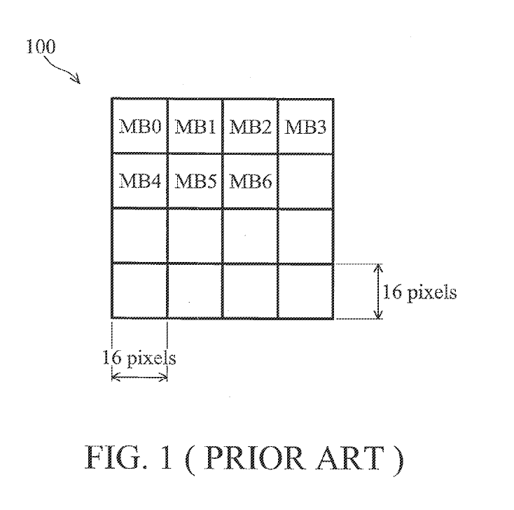

FIG. 2 is a diagram illustrating a systematical overview of a preferred embodiment;

FIG. 3 is an example of the preferred embodiment of FIG. 2; and

FIG. 4 is a flowchart illustrating a method according to the invention.

### DETAILED DESCRIPTION OF THE INVENTION

A preferred embodiment according to the present invention is a video operating and processing apparatus. The operating and processing may include coding, decoding transcoding or other processing. The video operating and processing apparatus, which may refer to a circuit, an integrated chip or a standalone device like a television or a media player, is used for operating and processing one or more than one video stream. Such video stream includes a series of frames and each frame includes a plurality of macroblocks.

Each macroblock may include color parameters or derived information corresponding to an area of pixels. For example, for a 16×16 macroblock that corresponds to 256 pixels, the data of the 16×16 macroblock may refer to raw color components, quantized data, offset values after prediction or any other derived information of different coding schemes corresponding to the 256 pixels. Most of current popular video coding adopt macroblock base coding, e.g. H.264, MPEG 2, MPEG 4, MPEG 7, AVC, VC-1, etc. When an image is coded in macroblock base, more similarities usually can be found among macroblocks in a same frame or in different frames. Such similarities can be utilized for increasing high compression ratio.

This invention to be explained below may be applied for any coding schemes that are based on macroblocks. For common implementation details for each coding schemes, persons skilled in the art may find lots of reference materials. With the following description, persons skilled in the art should know how to combine their common implementation and the features of the present invention. For example, H.264 is a coding scheme based on macroblocks. Persons skilled in the art may get an overall understanding for how to utilize macroblocks to achieve high compression ratio from many articles like, “Overview of the H.264/AVC Video Coding Standard,” in IEEE Transactions on Circuits and Systems for Video Technology, Vol. 13, No. 7, July 2003. In this article, Intra-Frame Prediction, Inter-Frame Prediction and other techniques like Slice Group are explained very clearly. Since such context knowledge is already known by persons skilled in the art, such context knowledge, except those related to integrate the invention, is not repeated here again.

When encoding or decoding macroblocks, sets of macroblock parameters corresponding to other related sets of macroblocks are usually necessary. For example, when encoding or decoding a current macroblock, several sets of macroblock parameters corresponding to other related sets of macroblocks neighboring to the current set of macroblocks are used for reference. Necessary macroblock parameters may be different for different coding schemes and sometimes may even be different for different coding tools even in the same coding scheme, e.g. H.264. Taking H.264 for an example, macroblock parameters may include, but are not limited to, Reconstructed pixels, Slice ID, Macroblock skip flag, Field decoding flag, Macroblock type, Direct mode flag, Luma intra modes, Chroma intra modes, Reference indices, Motion vectors, Motion vector differences, Coded block pattern, Quantization parameter, Y DC coded block flag, Y AC coded block flags, U DC coded block flag, U AC coded block flags, V DC coded block flag, V AC coded block flags, Y total coded block flags, Y total coefficients, U total coefficients, V total coefficients, etc. Please be noted that the term “a set of macroblock parameter” may refer to all or only a portion of available macroblock parameters. In addition, part of macroblock parameters may be stored in a local buffer like registers and some other portion may be stored in a DRAM, and such arrangement may be changed due to different design requirements.

In past, these macroblock parameters are usually stored directly and continuously bit by bit in a memory like a DRAM. In other words, these macroblock parameters buffered in a memory circuit are not specifically considered their characteristics. Taking an off-chip DRAM in an H.264 application as an example, each page miss may spend 8 DRAM clock cycles and 12 DRAM cycles for DDR and DDR2 DRAM, respectively. Meanwhile, when a macroblock parameter set takes 112 bytes, it needs only 7 DRAM clock cycles to read the macroblock parameter set. Such penalty of page miss is very large and the invention identifies this undiscovered technical problem and solves it by following ways.

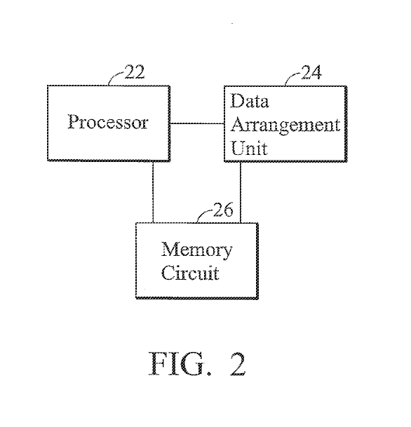

In the preferred embodiment, which is illustrated in FIG. 2, the video operating and processing apparatus includes a memory circuit 26, a processor 22 and a data arrangement unit 24. The memory circuit 26 is used for buffering intermediate processing results during operating and processing the video stream. The processor 22 is used for operating and processing the macroblocks according to sets of macroblock parameters. Each set of macroblock parameter is corresponding to a set of macroblocks. Sometimes, a set of macroblock parameter may be corresponding to only one macroblock and sometimes, a set of macroblock parameter may be corresponding to more than one macroblocks. The sets of macroblock parameters in the memory circuit 26 are stored by the data arrangement unit 24 that assigns addresses for storing the macroblock parameters by reference to a characteristic of the macroblock parameters, instead of storing these macroblock parameters directly and continuously bit by bit in the memory circuit 26.

In actual design, the processor 22 may be implemented as an integrated circuit or a plurality of circuits and necessary components that are capable of decoding or encoding a video stream. The operating and processing logic may be implemented in firmware instructions and/or hardware circuit logic directly. The processor 22 and the data arrangement unit 24 mentioned here may refer to corresponding instructions running on a controller or a microprocessor, or refer to hardware logic circuits, digital signal processor (DSP) and/or any of their combination. The processor 22 and the data arrangement unit 24 may also refer to a portion of an integrated chip or refer to various types of circuit combination in an end product like a H.264 player. Besides, related circuit logic can be implemented in the form of programs and can also be implemented in the form of ASIC.

When the macroblock parameters are obtained during processing, the macroblock parameters are stored by the data arrangement unit 24 for particular arrangement. If the processing is encoding, the macroblock parameters may be calculated by the processor 22 by encoding an image frame. If the processing is decoding, the macroblock parameters may be obtained by parsing a video stream and performing associated decoding. The data arrangement unit 24 may be implemented as firmware instructions and/or hardware logic controlled or executed by the processor 22 or an individual circuit that handles memory allocation during the processing and operating of the video stream.

It is to be noted that the data arrangement unit 24 determines addresses for storing the macroblock parameters by reference to at least one characteristic of the macroblock parameters. A first example of utilizing the characteristic of the macroblock parameters is to store macroblock parameters of an integer number of macroblocks in each page of the memory circuit. In other words, if there is still space in a memory page for storing partial data of one set of macroblock parameters, the space is not used. The data arrangement unit 24, on adopting such rule, determines storing the macroblock parameter in a next memory page. Such arrangement may prevent accessing parameters of one macroblock across two memory pages in the same memory bank of the memory circuit.

A second example for utilizing the characteristic of the macroblock parameter is to store macroblock parameters of one set of macroblocks across two memory pages, but these two memory pages are from different memory banks. Therefore, when accessing parameters of one macroblock, it takes less time to complete this access.

A third example for utilizing the characteristic for the macroblock parameter is to divide each set of macroblock parameters into groups. Different groups are stored in different banks of the memory circuit. For example, the macroblock parameter of “Motion Vector Information” may be classified into group one and the macroblock parameter of “Y total coefficients” may be classified into group two. Group one and group two are stored in different banks of the memory circuit. An option for such group dividing scheme is to keep each group or most groups having identical or similar size. What is called “similar size” here may refer to sizes that are substantially the same, e.g. 102 Kb, 101 Kb, 98 Kb for three groups. Another option for such group dividing is to classify the macroblock parameters by different coding tools. The term “coding tool” mentioned here may refer to any coding methods adopted. For example, if a first coding tool needs a first group of macroblock parameters and second coding tool needs a second group of macroblock parameters, the first group and the second group are stored in different banks of the memory circuit 26.

A fourth example for utilizing the characteristic for the macroblock parameter is to store two sets of macroblock parameters corresponding to two adjacent sets of macroblocks in different banks of the memory circuit 26. Such arrangement is useful because adjacent sets of macroblock are often necessary at the same time during processing.

A fifth example for utilizing the characteristic for the macroblock parameter is to store macroblock parameters of a same category together, where these macroblock parameters are from different sets of macroblock parameters. The term “together” used here may refer to store data in adjacent addresses. For example, the macroblock parameters of “Y DC coded block flag” from different macroblock parameter sets are stored together in the memory circuit. In actual design, the category may be determined by coding tools adopted.

It is to be noted that there are various way to construct “a set of macroblock” mentioned here. For example, a set of macroblocks may refer to one single macroblock. A set of macroblocks may also refer to two or more than two macroblocks that are adjacent or not directly adjacent. That is, a set of macroblocks may refer to two macroblocks that are horizontally or vertically adjacent to each other. Besides, the number of macroblocks in a set of macroblock may be any number under design requirement, e.g. 2ⁿ or 2 multiplying n, where n is a positive integer. The number of macroblocks corresponding to one set of macroblock parameter may also be changed dynamically, e.g. being adjusted frame by frame or slice by slice. The term of “set of macroblocks” does not need to be consistent with macroblock unit, which is referred to a basic unit for operating.

The memory circuit may be one ore more registers, DRAM, a SRAM, a flash memory, other types of storages or any combination of a plurality of such storage devices. The data arrangement unit 24 may arrange a portion of macroblock parameters in a local register, SRAM while some other portions of macroblock parameters in a DRAM. There are various arrangements depending on design requirements. The term of “set of macroblock parameters” may refer to all or only a portion of macroblock parameters.

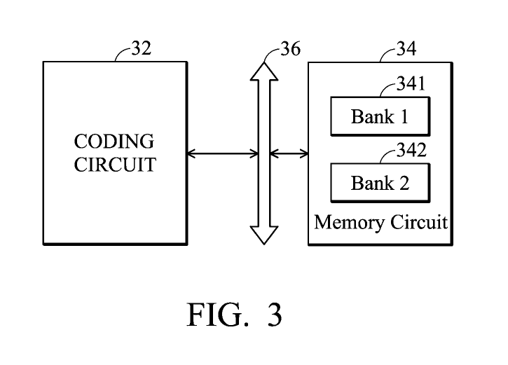

FIG. 3 illustrates an example of the preferred embodiment. In FIG. 3, a coding circuit 32 implements the functions of the processor 22 and the data arrangement unit 24. The coding circuit 32 access a memory circuit 34 via a bus 36 for reading and storing sets of macroblock parameters for encoding and/or decoding sets of macroblocks. There are two banks 341 and 342 which may separately store different groups of sets of macroblock parameters as mentioned above.

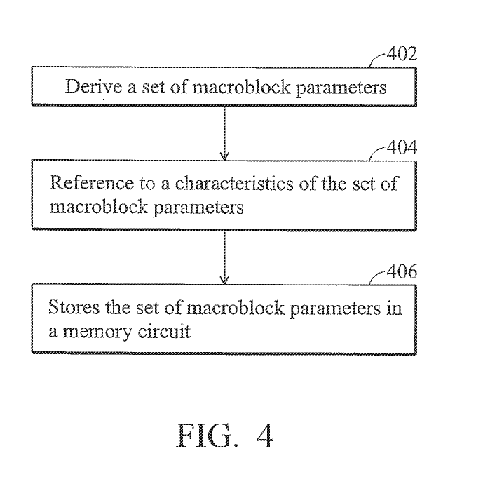

FIG. 4 is an exemplary flowchart, which illustrates a method for storing sets of macroblock parameters in a memory circuit according to at least one characteristic of macroblock parameters, instead of storing the macroblock parameters directly and continuously in the memory circuit bit by bit. In first step 402, a set of macroblock parameters are calculated and obtained. Then, a characteristic of the set of macroblock parameters is used (step 404) and then, the set of macroblock parameters are stored in a memory circuit (step 406). It is to be noted that the order of the step 401 and the step 402 may be exchanged. Such method can be implemented into instructions or into corresponding hardware logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video operating and processing apparatus for operating and processing a video stream, the video stream comprising a series of frames and each frame comprising a plurality of macroblocks, the apparatus comprising:
a memory circuit for buffering sets of macroblock parameters for operating and processing the video stream, each set of macroblock parameter corresponding to a set of the macroblocks;
a data arrangement unit for storing the sets of macroblock parameters in the memory circuit, the storing addresses of the memory circuit are determined by a characteristic of the macroblock parameters; and
a processor for operating and processing the macroblocks according to the sets of macroblock parameters.

2. The video operating and processing apparatus of claim 1, wherein the macroblock parameters contains information to be used in intra-prediction or inter-prediction.

3. The video operating and processing apparatus of claim 1, wherein the data arrangement unit arranges the macroblock parameters corresponding to an integer number of sets of macroblocks in each page of the memory circuit.

4. The video operating and processing apparatus of claim 1, wherein the data arrangement unit arranges macroblock parameters of one set of macroblocks to be stored across a first page and a second page of the memory circuit if the first page and the second page are at different banks of the memory circuit.

5. The video operating and processing apparatus of claim 1, wherein the data arrangement unit divides each set of macroblock parameters into groups, and the groups of one set of macroblock parameters are stored at different banks of the memory circuit.

6. The video operating and processing apparatus of claim 5, wherein the data arrangement unit divides the groups of one set of macroblock parameters by size so that the size of each group is identical or similar.

7. The video operating and processing apparatus of claim 5, the data arrangement unit divides the groups of one set of macroblock parameters according to different coding tools.

8. The video operating and processing apparatus of claim 1, wherein the arrangement unit stores different sets of macroblock parameters corresponding to different sets of macroblocks in different banks of the memory circuit.

9. The video operating and processing apparatus of claim 8, wherein composition of one set of macroblocks includes two adjacent macroblocks.

10. The video operating and processing apparatus of claim 1, wherein the data arrangement unit stores the same category of macroblock parameters among the set of macroblock parameters together in the memory circuit.

11. The video operating and processing apparatus of claim 10, wherein the category is determined by coding tools.

12. The video operating and processing apparatus of claim 1, wherein the set of macroblocks contains at least one macroblock.

13. The video operating and processing apparatus of claim 1, wherein the set of macroblocks contains two horizontally or vertically adjacent macroblocks.

14. The video operating and processing apparatus of claim 1, wherein the set of macroblocks contains 2ⁿ macroblocks, where n is a positive integer.

15. The video operating and processing apparatus of claim 1, wherein the size of the set of macroblocks is adjusted dynamically.

16. The video operating and processing apparatus of claim 15, wherein the size of the set of macroblocks is adjustable frame by frame.

17. The video operating and processing apparatus of claim 1, wherein the memory circuit is a DRAM, a SRAM or a Flash memory.

18. The video operating and processing apparatus of claim 1, wherein the processing is encoding or decoding.

19. A method for operating and processing a video stream, the video stream comprising a series of frames and each frame comprising a plurality of macroblocks, the method comprising:
storing sets of macroblock parameters in a memory circuit, each set of macroblock parameter corresponding to a set of the macroblocks, and the storing addresses of the memory circuit are determined by a characteristic of the macroblock parameters; and
processing the macroblocks according to the sets of macroblock parameters.

20. The method of claim 19, wherein an integer number of macroblock parameters is stored in each page of the memory circuit.

21. The method of claim 19, wherein parameters of one macroblock are stored across a first page and a second page of the memory circuit if the first page and the second page are at different banks of the memory circuit.

22. The method of claim 19, wherein each set of macroblock parameters is classified into groups, and the groups of one set of macroblock parameters are stored at different banks of the memory circuit.

23. The method of claim 19, wherein different sets of macroblock parameters corresponding to different sets of macroblocks are stored in different banks of the memory circuit.

24. The method of claim 23, wherein composition of one set of macroblocks includes 2ⁿ macroblocks, where n is a positive integer.

25. The method of claim 19, wherein the same category of macroblock parameters among the set of macroblock parameters are stored together in the memory circuit.

26. The method of claim 19, wherein the size of the set of macroblocks is adjusted dynamically.
